(19) United States
(12) Patent Application Publication
(10) Pub. No.: US 2018/0349380 A1
(43) Pub. Date: Dec. 6, 2018

(54) SYSTEMS AND METHODS FOR POINT-OF-INTEREST RECOGNITION

(71) Applicant: Nuance Communications, Inc., Burlington, MA (US)

(72) Inventors: Yuefeng Chen, Shanghai (CN); Ran Xu, Beijing (CN); Kesong Han, Shanghai (CN)

(73) Assignee: Nuance Communications, Inc., Burlington, MA (US)

(21) Appl. No.: 15/761,658

(22) PCT Filed: Sep. 22, 2015
(86) PCT No.: PCT/CN2015/090237

§ 371 Date: Mar. 20, 2018

(51) Int. Cl. G06F 17/30; G10L 19/00

(52) U.S. Cl. CPC G06F 17/3053; G10L 19/0018; G06F 17/30241; G06F 17/30619

(57) ABSTRACT

A system is provided, comprising at least one processor and at least one computer-readable storage medium. The at least one computer-readable storage medium may store a plurality of point-of-interest segment indices. The at least one computer-readable storage medium may further store instructions which program the at least one processor to: match a first text segment to a first point-of-interest segment index stored in the at least one computer-readable storage medium; match a second text segment to a second point-of-interest segment index stored in the at least one computer-readable storage medium; and use the first and second point-of-interest segment indices to identify one or more candidate point-of-interest entries matching both the first and second text segments.

### BACKGROUND

Some navigation systems, such as a navigation application for use on a mobile device (e.g., smartphone, tablet computer, etc.) or a navigation system onboard a vehicle, include a collection of points of interest. A point of interest (POI) may be any location to which a user may wish to navigate. Examples of points of interest include, but are not limited to, restaurants, hotels, retail stores, airports, train stations, parks, museums, gas stations, factories, etc.

Some navigation systems allow a user to search a point of interest using voice. For instance, the user may speak, “Logan International Airport.” The speech signal may be captured by a microphone and processed by the navigation system, for example, by matching the speech signal to an entry in a point-of-interest database. The navigation system may prompt the user to confirm that the identified point of interest is indeed what the user intended, and may set a course for that point of interest.

### SUMMARY

Aspects of the present disclosure relate to systems and methods for point-of-interest recognition.

In accordance with some embodiments, a system is provided, comprising at least one processor and at least one computer-readable storage medium storing a plurality of point-of-interest segment indices, wherein the at least one computer-readable storage medium further stores instructions which program the at least one processor to: match a first text segment to a first point-of-interest segment index stored in the at least one computer-readable storage medium; match a second text segment to a second point-of-interest segment index stored in the at least one computer-readable storage medium; and use the first and second point-of-interest segment indices to identify one or more candidate point-of-interest entries matching both the first and second text segments.

In accordance with some embodiments, a method is performed by a system comprising at least one processor and at least one computer-readable storage medium storing a plurality of point-of-interest segment indices, the method comprising acts of: matching a first text segment to a first point-of-interest segment index stored in the at least one computer-readable storage medium; matching a second text segment to a second point-of-interest segment index stored in the at least one computer-readable storage medium; and using the first and second point-of-interest segment indices to identify one or more candidate point-of-interest entries matching both the first and second text segments.

In accordance with some embodiments, at least one computer-readable storage medium is provided, storing a plurality of point-of-interest segment indices, the at least one computer-readable storage medium further storing instructions which program at least one processor perform a method comprising acts of: matching a first text segment to a first point-of-interest segment index stored in the at least one computer-readable storage medium; matching a second text segment to a second point-of-interest segment index stored in the at least one computer-readable storage medium; and using the first and second point-of-interest segment indices to identify one or more candidate point-of-interest entries matching both the first and second text segments.

### BRIEF DESCRIPTION OF DRAWINGS

Various aspects and embodiments of the present disclosure will be described with reference to the following figures.

FIG. 1 shows an illustrative point-of-interest recognition system 100, in accordance with some embodiments.

FIG. 2 shows an illustrative speech recognition system 200, in accordance with some embodiments.

FIG. 3 shows an illustrative process 300 that may be used to build an indexed point-of-interest database from an unsegmented point-of-interest database, in accordance with some embodiments.

FIG. 4 shows an illustrative point-of-interest recognition system 400, in accordance with some embodiments.

FIG. 5 shows an illustrative process 500 for matching an input text to one or more candidate point-of-interest entries, in accordance with some embodiments.

FIG. 6 shows, schematically, an illustrative computer 1000 on which one or more aspects of the present disclosure may be implemented.

### DETAILED DESCRIPTION

Aspects of the present disclosure relate to techniques for point-of-interest recognition. For example, techniques are provided for recognizing a point of interest from an input provided by a user to a navigation system. In some embodiments, the user input may be provided via speech. However, it should be appreciated that the techniques described herein are not limited to being used with any particular type of input, as in some embodiments one or more of the techniques may be used to process non-speech inputs (e.g., handwriting, typed text, etc.).

Some navigation systems use a client-server architecture. For instance, a client device (e.g., a smartphone, a computing device incorporated into the dashboard of a vehicle by a manufacturer, a computing device installed in a vehicle by a consumer, etc.) may capture a user input and transmit a request to a server computer based on the user input. The server computer may process the request and provide a response to the client device, and the client device may in turn render an output to the user based on the response received from the server computer.

By contrast, some navigation systems are capable of performing point-of-interest recognition without communicating with any server computer. For instance, an onboard navigation system may have a local storage of point-of-interest entries, and may be able to perform automatic speech recognition (ASR) processing locally.

A client-server architecture may provide some advantages. For example, compared to a client device, a server computer may have access to more resources such as storage and/or processing power. Thus, a server computer may be able to perform more robust recognition processing (e.g., by applying more sophisticated speech recognition techniques and/or searching for matches in a larger point-of-interest database). However, the inventors have recognized and appreciated that many users may prefer a local solution. As one example, due to privacy concerns, some users may prefer not to send search terms to a server computer. As another example, a cloud-based solution may become unusable where network connectivity is unavailable or of low quality (e.g., when a user is driving through a rural area or a tunnel).

Accordingly, in some embodiments, a point-of-interest recognition system may be provided that does not rely on communication with any server computer. For instance, improved techniques for point-of-interest recognition may be provided that use less storage and/or processing power. In some embodiments, the improved techniques may use about 60% less storage compared to conventional techniques. However, it should be appreciated that communication with a server computer is not necessarily precluded, as in some embodiments a point-of-interest recognition system may work in different modes, such as an online mode in which the point-of-interest system transmits requests and receives corresponding responses from a server computer, and an offline mode in which the point-of-interest recognition system performs point-of-interest recognition locally. In some embodiments, an offline mode may provide about 40% less latency compared to an online mode.

The inventors have recognized and appreciated that some countries or regions may have many points of interest. For example, according to some map data providers, China has over 20-30 million points of interest. Thus, if each point-of-interest name is treated as a recognizable word, there may be over 20-30 million recognizable words. The inventors have recognized and appreciated that such a large vocabulary size may negatively impact the performance of a point-of-interest recognition system, especially when operating in a resource-constrained environment (e.g., with limited processor speed, memory size, memory speed, cache size, etc.) commonly found on a mobile device such as a smartphone or an onboard computer in a vehicle. Accordingly, in some embodiments, techniques are provided for efficient storage and searching of point-of-interest entries.

The inventors have also recognized and appreciated some disadvantages of existing approaches to point-of-interest recognition. For instance, some point-of-interest recognition systems may perform poorly when a user identifies a point of interest in a way that is different from how the point of interest is represented in the point-of-interest recognition system. As an example, a point-of-interest recognition system may include a collection of points of interest that is compiled and maintained by a data provider (e.g., a professional map provider). In such a collection, the Logan Airport in Boston may be represented as “Boston Logan International Airport” in a point-of-interest entry. However, a user may not speak the full name when requesting point-of-interest information. For instance, the user may simply say, “Logan Airport,” or “Boston Logan.” As another example, a user may scramble the words in a point-of-interest name (e.g., because the user cannot remember or does not know exactly how the name is represented in a point-of-interest entry). For instance, instead of saying “the Mall at Chestnut Hill,” which may be the official name, the user may say “Chestnut Hill Mall.” Because the user input does not match the point-of-interest entry exactly, the system may fail to return the requested point-of-interest information even though the information exists in the system. Accordingly, in some embodiments, a point-of-interest recognition system may be provided that is more robust against partial and/or incorrect input.

In accordance with some embodiments, a collection of point-of-interest entries may be provided, where each point-of-interest name may be segmented. For instance, rather than storing the full phrase, “Boston Logan International Airport,” as a point-of-interest name, the phrase may be segmented and the resulting segments (e.g., “Boston”|“Logan”|“International”|“Airport”) may be stored in the point-of-interest entry.

A point-of-interest name may be segmented in any suitable way. For instance, in a language in which word boundaries are indicated by spaces (e.g., English, Spanish, German, French, etc.), a point-of-interest name may be segmented simply based on where spaces are found. Alternatively, or additionally, segmentation that is more or less fine grained may be used. As one example, a compound word (e.g., “airport”) may be segmented so that each component is in a separate segment (e.g., “air”|“port”). As another example, a collocation of two or more words (e.g., “opera house”) may be kept in one segment.

In a language in which word boundaries are not explicitly indicated (e.g., Chinese, Japanese, Korea, Thai, etc.), a suitable segmentation tool may be used to segment a point-of-interest name. For example, the point-of-interest name “ [symbol] [symbol] ” (“Shanghai Pudong International Airport”) may be segmented as “ [symbol] “ [symbol] “ [symbol] “ [symbol] ” (“Shanghai”|“Pudong”|“International”|“Airport”).

In accordance with some embodiments, a point-of-interest recognition system may store segments of point-of-interest names in an encoded form. For example, the entry “Boston City Hall” may be stored as <A, B, C>, where A, B, and C are, respectively, encodings for “Boston,” “City,” and “Hall.” In this manner, every occurrence of “Boston” in the collection of point-of-interest entries may be replaced with the encoding A. Likewise, every occurrence of “City” (respectively, “Hall”) may be replaced with the encoding B (respectively, C).

In some embodiments, a variable-length encoding method (e.g., a Huffman code) may be used, where segments that appear more frequently may have shorter encodings than segments that appear less frequently. For instance, the word “Boston” may appear frequently in a collection of point-of-interest names, and a short bit string may be used as an encoding for “Boston”. On the other hand, the word “Logan” may appear infrequently in a collection of point-of-interest names, and a long bit string may be used as an encoding for “Logan”. If a variable-length encoding method is used to generate a short encoding A for “Boston,” each replacement of the word “Boston” with the encoding A may represent a certain amount of reduction in storage. Because “Boston” occurs frequently in the collection of point-of-interest entries, significant overall savings may be achieved by accumulating many small amounts of reduction. Furthermore, by assigning shorter encodings to segments that appear more frequently and assigning longer encodings to segments that appear less frequently, the reduction in storage achieved through the segments that appear more frequently may more than offset the increase in storage incurred through the segments that appear less frequently. However, it should be appreciated that aspects of the present disclosure are not limited to the use of variable-length encoding, or any encoding at all.

In accordance with some embodiments, techniques for building a language model for point-of-interest recognition may be provided. For instance, a language model may include information for use in assigning probabilities to sequences of words, where a word may be a segment of a point-of-interest name and need not be the entire point-of-interest name. The language model may be of any suitable type, including, but not limited to, statistical grammar, n-gram model, etc.

In some embodiments, a language model may be trained using a collection of segmented point-of-interest names. For example, the point-of-interest name, “Boston Logan International Airport,” may be processed as a training sentence consisting of the words “Boston,” “Logan,” “International,” and “Airport.” Transition probabilities (e.g., the probability of observing the word “Airport” following the sequence “Boston,” “Logan,” “International”) may be computed based on the segmented point-of-interest names in the collection.

In some embodiments, segmented point-of-interest names may be used to create a context for automatic speech recognition (ASR). For example, a language model trained using a collection of segmented point-of-interest names may be augmented with pronunciation information to create an ASR context. In some embodiments, an ASR context may associate words in a language model with pronunciation information. For instance, the pronunciation of a first word may be different depending on a second word that precedes or follows the first word. As one example, the word “Quincy” may be associated with two different pronunciations, /□ k [symbol] nsi/ and /□ k [symbol] nzi/. When followed by the word “Massachusetts,” the word “Quincy” may tend to be pronounced as /□ k [symbol] nzi/. By contrast, when followed by the word “Illinois,” the word “Quincy” may tend to be pronounced as /□ k [symbol] nsi/. Transition probabilities (e.g., the probability of the word “Quincy” being pronounced as /□ k [symbol] nsi/ given that the following word is “Illinois”) may be trained using a corpus of recorded audio, or may be obtained from an established source of pronunciation information.

In accordance with some embodiments, an index may be created for a segment of a point-of-interest name. For instance, the index may indicate one or more point-of-interest entries in which that particular segment is found. As an example, a collection of point-of-interest names may include the following entries:

1. Boston City Hall

2. Faneuil Hall

3. Symphony Hall

4. Boston Common

In this example, an index for the word “Boston” may be created to indicate that “Boston” appears in entries 1 and 4. Similarly, an index for the word “Hall” may be created to indicate that “Hall” appears in entries 1-3. As explained below, such indices may be used to facilitate point-of-interest recognition (e.g., to improve robustness against partial and/or incorrect input).

In some embodiments, a point-of-interest recognition system may use indices for point-of-interest segments to perform recognition processing. For instance, for each recognized segment, the system may retrieve a corresponding index and use the index to identify the point-of-interest entries in which the recognized segment occurs. Thus, one or more sets of point-of-interest entries may be obtained, where each set includes one or more point-of-interest entries and corresponds to a recognized segment. One or more candidate point-of-interest entries may then be obtained by taking an intersection of these sets.

As an example, a user may speak “City Hall,” which may be segmented into the two-word sequence <“City,” “Hall”>. With reference to the above example, the index for the word “City” may indicate that “City” appears in entry 1, while the index for the word “Hall” may indicate that “Hall” appears in entries 1-3. Taking an intersection of the sets {1} and {1, 2, 3}, the system may determine that entry 1 is a candidate match. In this manner, a partial input (e.g., “City Hall,” rather than the full name “Boston City Hall”) may be correctly recognized. Furthermore, the recognition result may be the same even if the segments were input by the user in a different order (e.g., “City Hall Boston,” rather than “Boston City Hall”), because the set intersection operation is both commutative and associative.

It should be appreciated that the techniques introduced above and discussed in greater detail below may be implemented in any of numerous ways, as the disclosed techniques are not limited to any particular manner of implementation. The examples shown in the figures and described herein are provided solely for illustrative purposes.

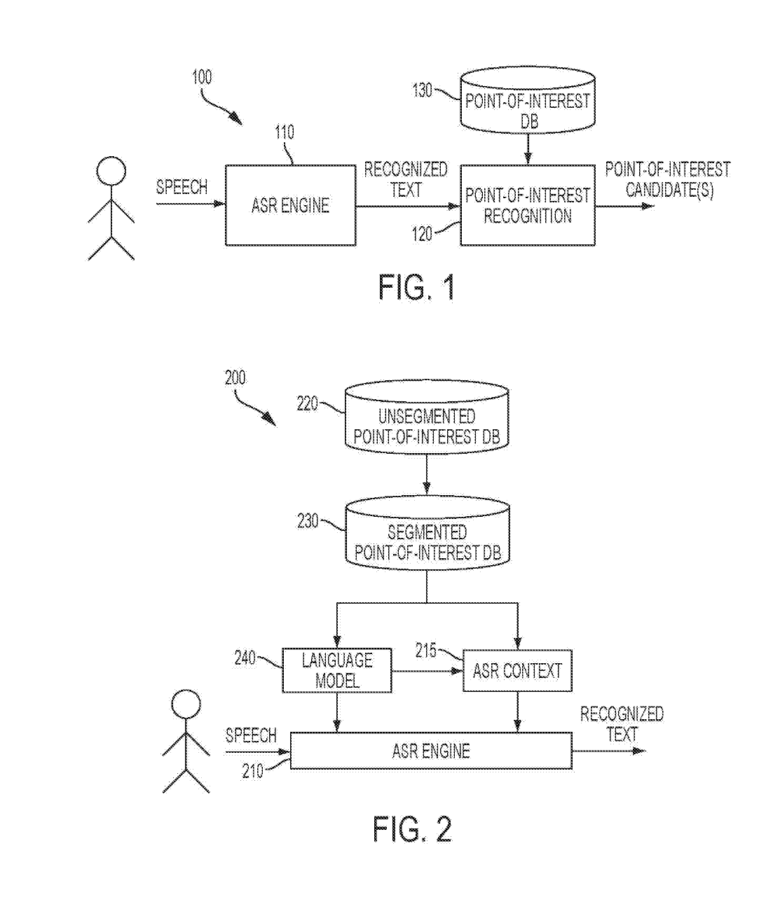

FIG. 1 shows an illustrative point-of-interest recognition system 100, in accordance with some embodiments. In this example, the point-of-interest recognition system 100 includes an automatic speech recognition (ASR) engine 110, a point-of-interest recognition component 120, and a point-of-interest database 130.

The illustrative point-of-interest recognition system 100 may be implemented in any suitable manner, for example, using at least one processor programmed by executable instructions and/or using specialized hardware. In some embodiments, the illustrative point-of-interest recognition system 100 may be implemented on one or more devices onboard a vehicle, such as a factory-installed onboard computer. Alternatively, or additionally, the one or more devices may include an aftermarket device, or simply a mobile device brought by a user.

The inventors have recognized and appreciated that the illustrative point-of-interest recognition system 100 may be implemented in a resource constraint environment. For instance, a device on which the illustrative point-of-interest recognition system 100 may be implemented may have a memory having a capacity of about 1 gigabyte, 2 gigabytes, 5 gigabytes, 10 gigabytes, 20 gigabytes, 50 gigabytes, 100 gigabytes, . . . , and may have a processor having a speed of about 500 megahertz, 800 megahertz, 1 gigahertz, 2 gigahertz, 5 gigahertz, 10 gigahertz, 20 gigahertz, 50 gigahertz, 100 gigahertz, . . . . However, the inventors have recognized and appreciated that the processor and/or memory may not be allocated entirely to recognition processing, but rather may be used also for other functions, such as music playback, telephone, Global Positioning System (GPS), etc. For instance, with about 1 gigabyte of memory available, only about 300 to 400 megabytes may be used for recognition processing. With resource-intensive features (e.g., autonomous driving) on the horizon, efficient storage and searching of point-of-interest entries may be advantageous even if the memory size is 100 gigabytes or more and/or the processor speed is 100 gigahertz or more.

In some embodiments, the ASR engine 110 may receive speech input from a user. For example, the user may speak “ [symbol] ” (“Pudong Shanghai Airport”). The ASR engine 110 may perform recognition processing on the speech input and output recognized text to the point-of-interest recognition component 120. In some embodiments, the recognized text output by the ASR engine 110 may be processed before being provided to the point-of-interest recognition component 120, for example, to remove extraneous words such as “I want to go to,” “We are going to,” “Navigate to,” etc. However, that is not required, as in some embodiments the ASR engine 110 may be configured to extract point-of-interest names from the speech input, and the recognized text output by the ASR engine 110 may be provided directly to the point-of-interest recognition component 120.

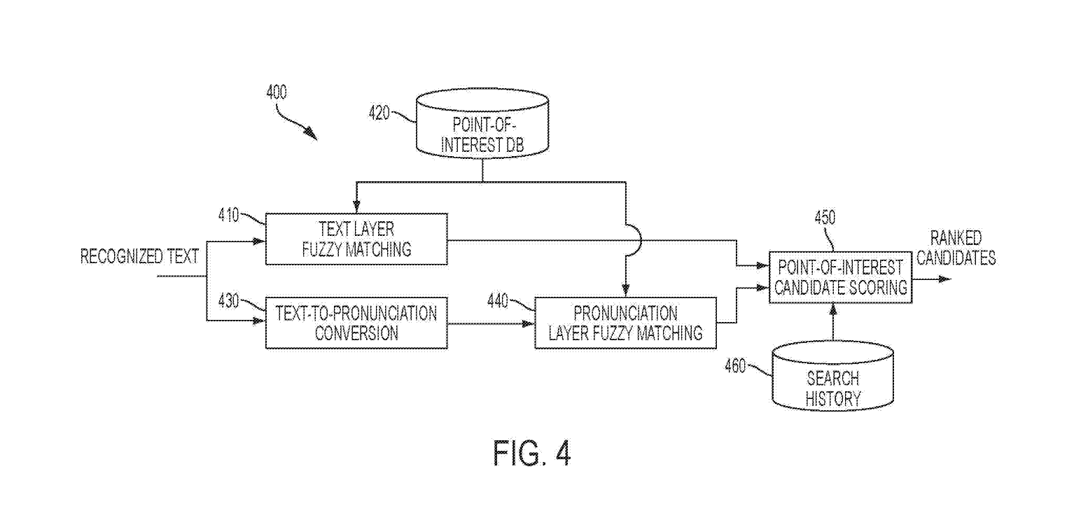

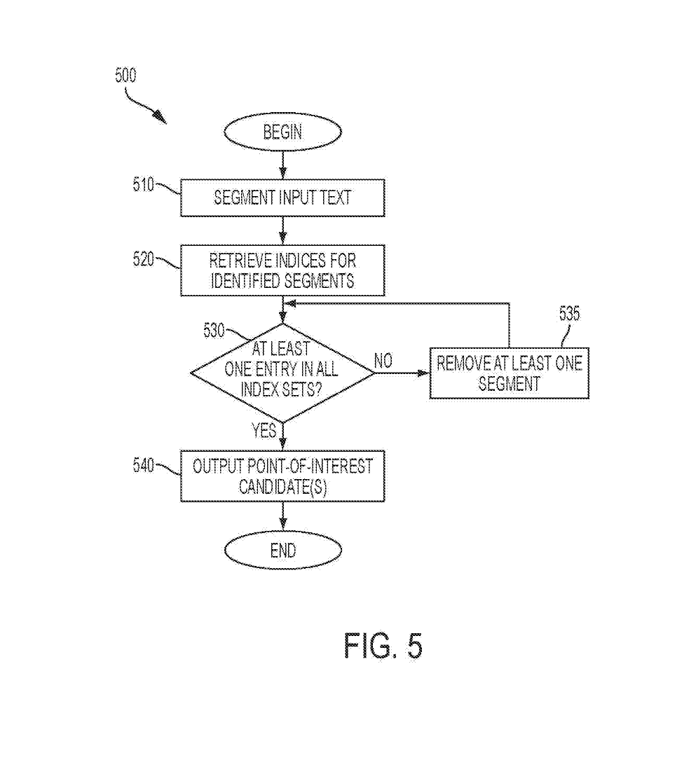

In some embodiments, the point-of-interest recognition component 120 may search the point-of-interest database 130 for one or more entries matching the recognized text. The inventors have recognized and appreciated that, in some instances, the recognized text output by the ASR engine 110 may be an incorrect and/or incomplete transcription of the query spoken by the user. As a result, the point-of-interest recognition component 120 may be unable to identify a matching entry in the point-of-interest database 130. Illustrative techniques for handling such errors are described below in connection with FIGS. 4-5.

In some embodiments, the point-of-interest recognition component 120 may segment the recognized text into input segments to facilitate the search for one or more matching entries in the point-of-interest database 130. For example, a recognized text “ [symbol] ” (“Pudong Shanghai Airport”) may be segmented into the input segments “ [symbol] “ [symbol] ” (“Pudong”|“Shanghai”|“Airport”). Any suitable segmentation technique for the appropriate language may be used, as aspects of the present disclosure are not limited to the use of any particular segmentation technique.

In some embodiments, point-of-interest names stored in the point-of-interest database 130 may have been segmented, for example, using a technique similar to that used by the point-of-interest recognition component 120 to segment a recognized text. In addition to the segmented point-of-interest names, the point-of-interest database 130 may store an index for at least one segment occurring in at least one point-of-interest name stored in the point-of-interest database 130.

For instance, in some embodiments, the point-of-interest database 130 may include the following illustrative point-of-interest entries.
Entry 0: [symbol] (Shanghai Pudong International Airport)
Entry 1: [symbol] (Pudong International Ceramic Factory)
Entry 2: [symbol] (Shanghai Western Brilliance¹)

In some embodiments, the illustrative entries may be segmented, for example, as “ [symbol] [symbol] [symbol] ” (“Shanghai|Pudong|International|Airport”), “ [symbol] [symbol] ” (“Pudong|International|Ceramic|Factory”), and “ [symbol] [symbol] ” (“Shanghai|Western|Brilliance”), respectively. An index may be created and stored for each segment, for example, to facilitate searching. In some embodiments, the following illustrative indices may be stored in the point-of-interest database 130.

In some embodiments, a head node of an index may be a segment occurring in at least one point-of-interest name stored in the point-of-interest database 130, and the remained nodes may record the entries in which that segment appears. For instance, the first illustrative index above corresponds to the word “ [symbol] ” (“Shanghai”), and indicates that this word appears in entry 0 and entry 2.

In some embodiments, indices stored in the point-of-interest database 130 may be sorted according to some suitable ordering. As one example, the point-of-interest name segment in each head node may be encoded into a number, and the indices may be sorted so that the encodings are in ascending or descending order. As another example, the point-of-interest name segments may not be encoded, and the indices may be sorted so that the point-of-interest name segments are in a lexicographic ordering. For instance, characters in the Chinese language may be ordered first by pronunciation (e.g., alphabetically based on pinyin), and then by the number of strokes in each character, or vice versa. Segments with multiple characters may be ordered as sequences of characters, with the first character being the most significant. Another suitable ordering may also be used, as aspects of the present disclosure are not limited to the use of any particular ordering.

The inventor has recognized and appreciated that sorting the indices stored in the point-of-interest database 130 may facilitate searching. For example, given an input segment (e.g., “ [symbol] ” or “Pudong”), an efficient search algorithm (e.g., binary search) may be used to quickly identify an index having a head node that matches the input segment (e.g., the second illustrative index in the above list), and the index may in turn be used to identify the point-of-interest entries in which the input segment occurs (e.g., entry 0 and entry 1).

In some embodiments, the point-of-interest recognition component 120 may search the indices stored in the point-of-interest database 130 to identify at least one matching index for each input segment obtained from the recognized text output by the ASR engine 110. For example, the input segments “ [symbol] ” (“Pudong”), “ [symbol] ” (“Shanghai”), and “ [symbol] ” (“Airport”) may be matched to the second, first, and fourth indices in the above list, respectively. The point-of-interest recognition component 120 may retrieve these indices from the point-of-interest database 130, and use these indices to determine one or more candidate point-of-interest entries.

1) The second index in the above list, <“ [symbol] ” (“Pudong”), 0, 1>, may indicate that the target point-of-interest entry is either entry 0 or entry 1, because “ [symbol] ” (“Pudong”) occurs only in these entries.

2) The first index in the above list, <“ [symbol] ” (“Shanghai”), 0, 2>, may indicate that the target point-of-interest entry is either entry 0 or entry 2, because [symbol] ” (“Shanghai”) occurs only in these entries.

3) The fourth index in the above list, <“ [symbol] ” (“Airport”), 0> may indicate that the target point-of-interest entry must be entry 0, because [symbol] ” (“Airport”) occurs only in entry 0.

In this manner, the point-of-interest recognition component 120 may obtain one or more sets of point-of-interest entries, each set including one or more point-of-interest entries and corresponding to an input segment. For example, the point-of-interest recognition component 120 may use the index <“ [symbol] ” (“Pudong”), 0, 1> to identify a set {entry 0, entry 1}, which corresponds to the input segment “ [symbol] ” (“Pudong”). Similarly, the point-of-interest recognition component 120 may use the index <“ [symbol] ” (“Shanghai”), 0, 2> to identify a set {entry 0, entry 2}, which corresponds to the input segment “ [symbol] ” (“Shanghai”), and the point-of-interest recognition component 120 may use the index <“ [symbol] ” (“Airport”), 0>to identify a set {entry 0}, which corresponds to the input segment “ [symbol] ” (“Airport”).

In some embodiments, the point-of-interest recognition component 120 may take an intersection of sets of point-of-interest entries to determine one or more candidate point-of-interest entries. For example, the point-of-interest recognition component 120 may take an intersection of the sets, {entry 0, entry 1}, {entry 0, entry 2}, and {entry 0}, which were obtained based on the input segments, “ [symbol] ” (“Pudong”), “ [symbol] ” (“Shanghai”), and “ [symbol] ” (“Airport”), respectively. The intersection of these sets may include only one entry, namely, entry 0, and this entry may be returned as a point-of-interest recognition result. The result may be provided to the user for confirmation, and/or to a navigation system so that the navigation system may set a course accordingly.

In some embodiments, the point-of-interest recognition component 120 may not retrieve a corresponding index for every input segment obtained from the recognized text output by the ASR engine 110. For instance, in the above example, the indices <“ [symbol] ” (“Pudong”), 0, 1> and <“ [symbol] ” (“Shanghai”), 0, 2> may be sufficient to narrow the pool of candidate point-of-interest entries down to one candidate, namely, entry 0. Thus, the point-of-interest recognition component 120 may stop without retrieving an index for “ [symbol] ” (“Airport”), which may improve response time of the point-of-interest recognition system 100.

The inventors have recognized and appreciated that the illustrative techniques described above may be robust against some types of errors made by a user. For instance, in the above example, the user provided an incomplete point-of-interest name, with the word “ [symbol] [symbol] ” (“International”) missing, as the full point-of-interest name is “ [symbol] ” (“Shanghai Pudong International Airport”). Furthermore, the user reordered two segments, namely, “ [symbol] ” (“Pudong Shanghai”), as opposed to “ [symbol] ” (“Shanghai Pudong”). Despite these errors, the point-of-interest recognition component 120 may be able to correctly match the speech input to the point-of-interest entry “ [symbol] ” (“Shanghai Pudong International Airport”). In some embodiments, an error rate may be reduced by more than 50% using some of the techniques described herein.

Although various examples are described above in connection with FIG. 1, it should be appreciated that such examples are provided solely for purposes of illustration. For example, aspects of the present disclosure are not limited to implementing speech recognition and point-of-interest recognition using two separate components, as in some embodiments a single component may perform both functions.

FIG. 2 shows an illustrative speech recognition system 200, in accordance with some embodiments. In this example, the speech recognition system 200 includes an automatic speech recognition (ASR) engine 210, which may be configured to perform speech recognition processing using a language model 240 and/or an ASR context 215. In some embodiments, the automatic speech recognition (ASR) engine 210 may be used in a point-of-interest recognition system (e.g., the illustrative point-of-interest recognition system 100 shown in FIG. 1).

The illustrative speech recognition system 200 may be implemented in any suitable manner, for example, using at least one processor programmed by executable instructions and/or using specialized hardware. In some embodiments, the illustrative speech recognition system 200 may be implemented on a device onboard a vehicle. The device may be a factory-installed onboard computer. Alternatively, or additionally, the device may be an aftermarket device, or simply a mobile device brought by a user.

In some embodiments, one or both of the language model 240 and the ASR context 215 may be built using a segmented point-of-interest database 230, which in turn may be built using an unsegmented point-of-interest database 220. In some embodiments, the unsegmented point-of-interest database 220 and/or the segmented point-of-interest database 230 may be stored at a location external to the device on which speech recognition system 200 is implemented, or may not be stored at all after being used to generate the language model 240 and/or the ASR context 215. As a result, the amount of storage that is used by the speech recognition system 200 may be reduced.

The inventors have recognized and appreciated that segmentation may be used to reduce a vocabulary size for a speech and/or point-of-interest recognition system. For example, in a large country like China, there may be over 20-30 million points of interest. If each point-of-interest name is treated as a recognizable word, there may be over 20-30 million recognizable words. The inventors have recognized and appreciated that each point-of-interest name may be a combination of one or more segments, and there may be a much smaller number of possible segments (e.g., one or two million different segments). Thus, by treating each segment (as opposed to an entire point-of-interest name) as a recognizable word, the vocabulary size may be reduced significantly (e.g., from tens of millions of words to a few million words).

In some embodiments, a desired vocabulary size may be identified based on any suitable combination of one or more factors, such as constraints associated with an environment in which a speech and/or point-of-interest recognition system is expected to operate. Examples of such constraints include, but are not limited to, processor speed, memory size, memory speed, etc. Once identified, a desired vocabulary size may be achieved by adjusting a level of granularity of segmentation. For instance, in some embodiments, an iterative process may be used, where in each iteration some level of granularity may be used for segmenting point-of-interest names and, depending on whether the resulting vocabulary size is too large or too small, the level of granularity may be either increased or decreased. Such an iteration may be repeated until the desired vocabulary size is achieved.

In a language in which word boundaries are indicated by spaces (e.g., English, Spanish, German, French, etc.), a point-of-interest name may be segmented simply based on where spaces are found. Alternatively, or additionally, segmentation that is more or less fine grained may be used, for instance, to achieve a desired vocabulary size as described above. As one example, a compound word (e.g., “airport”) may be segmented so that each component is in a separate segment (e.g., “air”|“port”). As another example, a collocation of two or more words (e.g., “opera house”) may be kept in one segment.

In a language in which word boundaries are not explicitly indicated (e.g., Chinese, Japanese, Korea, Thai, etc.), a suitable segmentation tool may be used to segment a point-of-interest name. For example, the point-of-interest name “ [symbol] ” (“Shanghai Pudong International Airport”) may be segmented as “ [symbol] “ [symbol] “ [symbol] ” (“Shanghai”|“Pudong”|“International”|“Airport”).

Any one or more suitable techniques may be used to perform segmentation. For example, in some embodiments, an interactive process may be used to train a segmentation model, which may be a segmentation model based on conditional random fields (CRFs), hidden Markov models (HMMs), etc. For instance, a labeled training set may be used to build a segmentation model, which may then be used to segment a set of unlabeled data. One or more errors may be tagged by a human and used to adapt the segmentation model. This process may be repeated until a certain degree of accuracy is achieved.

In some embodiments, a labeled training set may include a point-of-interest name divided into three segments labeled, respectively, “Beginning,” “Middle,” and “End.” For example, the point-of-interest name “ [symbol] ” (“Shanghai Pudong International Airport”) may be segmented as “ [symbol] ” [symbol] ” (“Shanghai”|“Pudong”|“International”“Airport”), where the segment “ [symbol] ” (“Shanghai”) may be labeled with “Beginning,” the segments “ [symbol] ” and “ [symbol] ” (“Pudong” and “International”) may be labeled with “Middle,” and the segment “ [symbol] ” (“Airport”) may be labeled with “End.” However, it should be appreciated that aspects of the present disclosure are not limited to the use of any particular set of labels, or to any particular level of segmentation granularity.

Referring again to FIG. 2, in some embodiments, a suitable segmentation model may be used to segment point-of-interest names in the unsegmented point-of-interest database 220, and the resulting segmented point-of-interest database 230 may be used to build the language model 240. The language model 240 may include statistical information indicative of how frequently certain sequences of segments are observed in the segmented point-of-interest database 230. For instance, the collocation “ [symbol] “ [symbol] ” (“Shanghai”|“Pudong”) may occur more frequently in the segmented point-of-interest database 230 than the collocation “ [symbol] ” (“Shanghai”|“Western”). As a result, the language model 240 may assign a higher transition probability to “ [symbol] ” (“Pudong”) than to “ [symbol] ” (“Western”) given that the preceding segment is “ [symbol] ” (“Shanghai”).

In some embodiments, the segmented point-of-interest database 230 and/or the language model 240 may be used to build the ASR context 215. For instance, the language model 240 may be augmented with pronunciation information to create the ASR context 215. Alternatively, or additionally, one or more point-of-interest names from the segmented point-of-interest database 230, along with associated pronunciation information, may be used to create the ASR context 215. The ASR context 215 may be a grammar-based context, or a context of another suitable type.

In some embodiments, the ASR context 215 may include phonetic transition probabilities indicative of how words may be pronounced differently depending on surrounding words. For example, the word “Quincy” may be associated with two different pronunciations, /□ k [symbol] nsi/ and /□ k [symbol] nzi/. When followed by the word “Massachusetts,” the word “Quincy” may tend to be pronounced as /□ k [symbol] nzi/. By contrast, when followed by the word “Illinois,” the word “Quincy” may tend to be pronounced as /□ k [symbol] nsi/. Accordingly, the ASR context 215 may associate different probabilities with the different pronunciations of “Quincy” depending on which word is found following “Quincy” (e.g., “Massachusetts” vs. “Illinois”). Such phonetic transition probabilities may be trained using a corpus of recorded audio, or may be obtained from an established source of pronunciation information.

The inventors have recognized and appreciated various advantages of using a segmented point-of-interest database to create a language model and/or ASR context for use in speech recognition. For instance, as discussed above, a language model and/or ASR context created using segments of point-of-interest names, as opposed to entire point-of-interest names, may have a reduced vocabulary size and as such may take up less storage. Furthermore, using a language model and/or ASR context created from point-of-interest names, as opposed to a general purpose language model and/or ASR context may improve speech recognition accuracy (e.g., by eliminating, as possible recognition results, sequences of words that are not likely to be spoken by a user interacting with a point-of-interest recognition system). However, it should be appreciated that aspects of the present disclosure are not limited to the use of a point-of-interest database (segmented or unsegmented) to create a language model or ASR context.

In some embodiments, the ASR engine 210 may use the language model 240 and/or the ASR context 215 to process speech captured from a user. For instance, the ASR engine 210 may use the language model 240 and/or the ASR context 215 to match the speech input to a most likely sequence of sounds, and a sequence of words corresponding to the most likely sequence of sounds may be output as a recognized text. In some embodiments, the ASR engine 210 may output an n-best result comprising n sequence of words corresponding respectively to the n most likely sequences of sounds, and each such sequence of words may be associated with a confidence score indicative of how well the corresponding sequence of sounds matches the speech input.

Although various examples are described above in connection with FIG. 2, it should be appreciated that such examples are provided solely for purposes of illustration. For instance, aspects of the present disclosure are not limited to implementing an ASR context as a module separate from an ASR engine, as in some embodiments an ASR context may be incorporated into an ASR engine. Furthermore, in some embodiments, one or more of the techniques described in connection with FIG. 2 may be used to recognize speech input other than point-of-interest queries. For example, a database of terms other than point-of-interest names (e.g., medical terms) may be segmented and used to create a language model and/or ASR context. Further still, in some embodiments, segmentation of a point-of-interest database, creation of a language model, and/or creation of an ASR context may be performed by a system that is different from a system that performs speech and/or point-of-interest recognition. For example, segmentation of a point-of-interest database, creation of a language model, and/or creation of an ASR context may be performed by a vendor of point-of-interest recognition software, and the segmented point-of-interest database, the language model, and/or the ASR context may be loaded onto a system that performs speech and/or point-of-interest recognition (e.g., a computer integrated into a vehicle, or a mobile phone).

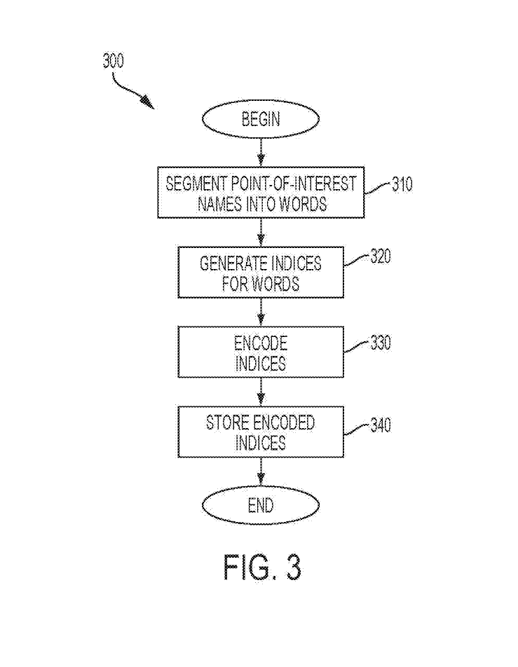

FIG. 3 shows an illustrative process 300 that may be used to build an indexed point-of-interest database from an unsegmented point-of-interest database, in accordance with some embodiments. For example, the process 300 may be used to build the illustrative point-of-interest database 130 shown in FIG. 1. In some embodiments, the process 300 may be performed during an offline stage, for example, by a vendor of point-of-interest recognition software. The resulting indexed point-of-interest database may be loaded onto a device for use in point-of-interest recognition (e.g., a computer integrated into a vehicle, or a mobile phone).

At act 310, one or more point-of-interest names may be retrieved from an unsegmented point-of-interest database, such as the illustrative unsegmented point-of-interest database 220 shown in FIG. 2. The one or more point-of-interest names may be segmented using any one or more suitable techniques, including, but not limited to, those described above in connection with FIG. 2. In some embodiments, all of the point-of-interest names in the unsegmented point-of-interest database may be segmented. However, that is not required, as in some embodiments some point-of-interest names may not be segmented (e.g., point-of-interest names that do not exceed a certain threshold length).

In some embodiments, segmented point-of-interest names may be stored in a segmented point-of-interest database such as the illustrative point-of-interest database 230 shown in FIG. 2. Such a segmented point-of-interest database may be used both to generate the illustrative point-of-interest database 130 shown in FIG. 1, which is used to perform point-of-interest recognition, and to generate the illustrative language model 240 and/or the illustrative ASR context 215 shown in FIG. 2, which are used to perform speech recognition. However, it should be appreciated that aspects of the present disclosure are not limited to using the same segmented point-of-interest database for speech recognition and point-of-interest recognition. In some embodiments, speech recognition may be performed using a generic language model and/or a generic ASR context.

At act 320, an index may be generated for a segment occurring in at least one point-of-interest name, for example, as described above in connection with FIG. 1. For instance, in some embodiments, the unsegmented point-of-interest database may include the following illustrative point-of-interest entries.
Entry 0: [symbol] (Shanghai Pudong International Airport)
Entry 1: [symbol] (Pudong International Ceramic Factory)
Entry 2: [symbol] (Shanghai Western Brilliance)

These entries may be segmented, for example, as “ [symbol] [symbol] ” (“Shanghai|Pudong|International|Airport”), “ [symbol] [symbol] ” (“Pudong|International|Ceramic|Factory”), and “ [symbol] ” (“Shanghai|Western|Brilliance”), respectively.

In some embodiments, an index may be created for each segment, as shown below. Each index may include a list having one or more nodes. The corresponding segment (e.g., “ [symbol] ” or “Shanghai”) may be stored at a head node, while each remaining node may store an identifier for a point-of-interest entry in which the segment appears (e.g., entry 0 and entry 2 for the segment “ [symbol] ” or “Shanghai”). However, it should be appreciated that aspects of the present disclosure are not limited to storing an index as a list, as another type of data structure (e.g., binary tree) may also be used to store information indicative of one or more point-of-interest entries in which the corresponding segment occurs.

At act 330, one or more indices may be encoded, for example, to reduce an amount of space used to store the one or more indices. The inventors have recognized and appreciated that variable-length encoding may be used to achieve significant storage savings. For instance, in some embodiments, a shorter encoding may be used for a segment that appears in many point-of-interest entries and thus has a large index, whereas a longer encoding may be used for a segment that appears in only one or a few entries and thus has a small index. Any suitable variable-length encoding scheme may be used, including, but not limited to, a Huffman code.

For example, let I₀, . . . , I₇ denote the eight illustrative indices above, corresponding respectively to the segments “ [symbol] ” (“Shanghai”), “ [symbol] ” (“Pudong”), “ [symbol] ” (“International”), “ [symbol] ” (“Airport”), “ [symbol] ” (“Ceramic”), “ [symbol] ” (“Factory”), “ [symbol] ” (“Western”), and “ [symbol] ” (“Brilliance”). The index I₀ includes two entries (entry 0 and entry 2), whereas the index I₇ includes only one entry (entry 2). Accordingly, in some embodiments, a shorter encoding may be used for “ [symbol] ” (“Shanghai”), while a longer encoding may be used for “ [symbol] ” (“Brilliance”).

In some embodiments, a delta encoding method may be used to encode one or more point-of-interest entry identifiers in an index. The inventors have recognized and appreciated that delta encoding may be effective in reducing an amount of space used to store an index, for example, when a point-of-interest database includes a large number of entries (e.g., millions or tens of millions). For instance, the inventors have recognized and appreciated that as the size of a point-of-interest database grows, the length of an identifier (e.g., an automatically generated database primary key) for each entry may grow accordingly. Thus, an index for a segment like “ [symbol] ” (“Shanghai”), which may appear frequently in a point-of-interest database, may include a long list of point-of-interest entry identifiers, where each identifier may be a large number. The inventors have recognized and appreciated that a delta encoding method may be used to reduce an amount of information that is stored for such an index.

For purposes of illustration, assume that an index for a segment (e.g., “ [symbol] ” or Shanghai”) includes the following point-of-interest entry identifiers:
. . . , 1000000, 1000024, 1000031, . . .

Rather than storing each of these large numbers, a starting point may be stored, such as 1000000. For each subsequent identifier, a difference (or delta) between that identifier and a previous identifier may be stored. Thus, in this example, the following may be stored instead:
. . . , 1000000, 24, 7, . . .

During a decoding process, the identifier 1000024 may be recovered by adding 24 to 1000000, the identifier 1000031 may be recovered by adding 7 to 1000024, and so on. The inventors have recognized and appreciated that significant storage savings may be achieved by replacing large numbers (e.g., 1000024, 1000031, etc.) with small numbers (e.g., 24, 7, etc.).

Even though additional processing time may be needed during decoding (e.g., to accumulate several delta values to recover an identifier), the inventors have recognized and appreciated that such a delay may not significantly impact user experience. For example, in some embodiments, decoding may be performed when a point-of-interest application is loaded into memory, so a user may experience some delay when launching the application. Decoded indices may be kept in memory, so that no decoding may be needed when processing a point-of-interest query spoken by a user. However, it should be appreciated that aspects of the present disclosure are not limited to performing decoding up front, as in some embodiments decoding may be performed on an as-needed basis, or a hybrid approach may be adopted (e.g., decoding indices for more frequently encountered segments up front and indices for less frequently encountered segments as needed).

At act 340, one or more encoded indices may be stored, for example, in an indexed point-of-interest database. In some embodiments, the stored indices may be sorted according to some suitable ordering. For example, the point-of-interest name segment in each head node may be encoded into a number (e.g., using a variable-length encoding scheme as discussed above), and the indices may be sorted so that the encodings of the segments are in ascending order. The inventor has recognized and appreciated that sorting the indices in this manner may facilitate searching. For example, given an input segment (e.g., “ [symbol] ” or “Pudong”), an encoding of the input segment may be computed, and an efficient search algorithm (e.g., binary search) may be used to quickly identify an index having a head node that matches the encoding. However, it should be appreciated that aspects of the present disclosure are not limited to storing sorted indices, as in some embodiments, sorting may be performed when the indices are decoded and loaded into memory (e.g., when the point-of-interest recognition system is launched by a user).

In some embodiments, a table of point-of-interest entries may be stored in addition to, or instead of indices for segments of point-of-interest names. For example, let E₀, . . . , E₇ denote the results of encoding the eight segments “ [symbol] ” (“Shanghai”), “ [symbol] ” (“Pudong”), “ [symbol] ” (“International”), “ [symbol] ” (“Airport”), “ [symbol] ” (“Ceramic”), “ [symbol] ” (“Factory”), “ [symbol] ” (“Western”), and “ [symbol] ” (“Brilliance”). respectively. The following entries may be generated and stored in the indexed point-of-interest database.
Entry 0: E₀|E₁|E₂|E₃
Entry 1: E₁|E₂|E₄|E₅
Entry 2: E₀|E₆|E₇

Thus, in this example, each occurrence of the segment “ [symbol] ” (“Shanghai”) may be replaced by the corresponding encoding E₀, and likewise for the other segments. If a variable-length encoding method is used to generate a short encoding for “ [symbol] ” (“Shanghai”), each replacement of the segment “ [symbol] ” (“Shanghai”) with the encoding E₀ may represent a certain amount of reduction in storage. Since “ [symbol] ” (“Shanghai”) occurs in many point-of-interest entries, significant overall savings may be achieved by accumulating many small amounts of reduction.

Furthermore, the inventors have recognized and appreciated that, by assigning shorter encodings to segments that appear more frequently and assigning longer encodings to segments that appear less frequently, the reduction in storage achieved through the segments that appear more frequently may more than offset the increase in storage incurred through the segments that appear less frequently. For instance, the segment “ [symbol] ” (“Brilliance”) may occur only in one or a few point-of-interest entries. Even if replacing the segment “ [symbol] ” (“Brilliance”) with the encoding E₇ may represent a certain amount of increase in storage, such an increase may occur only once or a few times. Thus, the overall increase caused by using longer encodings for less frequently occurring segments like “ [symbol] ” (“Brilliance”) may be offset by the overall decrease achieved by using shorter encodings for more frequently occurring segments like “ [symbol] ” (“Shanghai”).

Although various examples are described above in connection with FIG. 3, it should be appreciated that such examples are provided solely for purposes of illustration. For instance, while the inventors have recognized and appreciated various advantages of applying variable-length encoding to segments of point-of-interest names, aspects of the present disclosure are not so limited. In some embodiments, one or more other types of encoding may be used in addition to, or instead of, variable-length encoding, or no encoding at all may be used. Furthermore, aspects of the present disclosure are not limited to the use of decimal numbers as point-of-interest entry identifiers, as in some embodiments other values may be used, including, but not limited to, bit strings, character strings, hexadecimal numbers, etc.

FIG. 4 shows an illustrative point-of-interest recognition system 400, in accordance with some embodiments. The point-of-interest recognition system 400 may receive an input text and attempt to match the input text to one or more point-of-interest entries in a point-of-interest database 420. The input text may be recognized from a user utterance, for example, by the illustrative ASR engine 210 shown in FIG. 2. However, in some embodiments, the point-of-interest recognition system 400 may alternatively, or additionally, be used to process an input text from another source (e.g., typed in by a user, recognized from handwriting, received over a network, etc.)

In some embodiments, the point-of-interest database 420 may include segmented point-of-interest names. The segments may be indexed and/or encoded, for example, as described above in connection with FIG. 3. However, it should be appreciated that aspects of the present disclosure are not limited to segmenting point-of-interest names, or to indexing or encoding segments. For instance, the techniques described herein for matching input text to one or more point-of-interest entries may be applied using an unsegmented point-of-interest database.

In some embodiments, the point-of-interest recognition system 400 may use one or more of the techniques described above in connection with FIG. 1 to identify one or more point-of-interest entries that match the input text textually. Alternatively, or additionally, the point-of-interest recognition system 400 may generate a phonetic representation of the input text. For instance, in the example shown in FIG. 4, the point-of-interest recognition system 400 includes a text-to-pronunciation conversion component 430, which may be programmed to process an input text and output a phonetic representation of the input text. For example, an input text in Chinese may include a string of Chinese characters (e.g., “ [symbol] ”). The text-to-pronunciation conversion component 430 may map each character to a phonetic representation in some appropriate system such as Pinyin (e.g., “pu” for “ [symbol] ,” “dong” for “ [symbol] ,” “ji” for “ [symbol] ,” and “chang” for “ [symbol] ”). The point-of-interest recognition system 400 may then search the point-of-interest database 420 for point-of-interest names having matching pronunciation (e.g., without tones, “pu dong ji chang,” or with tones, “pu-3 dong-1 ji-1 chang-3”). For example, in some embodiments, the point-of-interest database 420 may store phonetic representations of segments of point-of-interest names, and the phonetic representations may be encoded (e.g., using 32-bit cyclic redundancy check) and/or sorted to facilitate searching (e.g., so that binary search may be used).

In some embodiments, the point-of-interest recognition system 400 may identify multiple candidate point-of-interest entries. For example, in Chinese, the character “ [symbol] ” (as in “ [symbol] ,” which means “Airport”) may have the same pronunciation as the character “ [symbol] ” (as in “ [symbol] ,” which means “Factory”). Therefore, both entries below may be candidates for the input text (e.g., “ [symbol] ”).
Entry 0: [symbol] (Shanghai Pudong International Airport)
Entry 1: [symbol] (Pudong International Ceramic Factory)

In the example shown in FIG. 4, the point-of-interest recognition system 400 includes a point-of-interest candidate scoring component 450, which may be programmed to score and/or rank multiple candidate point-of-interest entries. For instance, the scoring component 450 may assign a higher score to entry 1 above as a match for the input text “ [symbol] ,” because entry 1 matches the input text textually as well as in pronunciation. By contrast, the scoring component 450 may assign a lower score to entry 0 above, because entry 0 matches the input text in pronunciation but there is a mismatch in one character (i.e., “ [symbol] ” instead of “ [symbol] ”). Nevertheless, both entries may be presented to the user (e.g., with entry 1 presented first, as entry 1 received a higher score). In this manner, even if the user actually spoke “ [symbol] ” (“Pudong Airport”) but the ASR engine misrecognized the speech input as “ [symbol] ” (“Pudong Factory”), the point-of-interest recognition system 400 may be able to identify the intended point of interest as a candidate.

In some embodiments, the scoring component 450 may be programmed to use history information to adjust a score assigned to a candidate point-of-interest entry. For instance, the scoring component 450 may access a search history database 460, which may include history information relating to a specific user and/or history information relating to a population of users. As one example, the history information may indicate that users in the population search “ [symbol] [symbol] ” (“Shanghai Pudong International Airport”) more frequently and/or more recently than “ [symbol] ” (“Pudong International Ceramic Factory”). Accordingly, the scoring component 450 may assigner a higher score to the former than the latter. As another example, the history information may indicate that the user who issued the query searches “ [symbol] [symbol] ” (“Shanghai Pudong International Airport”) less frequently and/or less recently than “ [symbol] ” (“Pudong International Ceramic Factory”). Accordingly, the scoring component 450 may assigner a lower score to the former than the latter. In some embodiments, the scoring component 450 may give more weight to information specific to the user who issued the query. However, that is not required, as in some embodiments the scoring component 450 may instead give more weight to population information.

In some embodiments, the scoring component 450 may be programmed to use contextual information to adjust a score assigned to a candidate. For instance, the scoring component 450 may be programmed to use contextual information to classify a user who issued a point-of-interest query. The classification result may be then used to adjust a score assigned to a candidate point-of-interest entry. As one example, the scoring component 450 may be programmed to use contextual information to determine that the user is likely a pedestrian. In response to determining that the user is likely a pedestrian, the scoring component 450 may assign higher scores to points of interest within walking distance from the user's current location.

As another example, the scoring component 450 may be programmed to use contextual information to determine that the user is likely a motorist. In response to determining that the user is likely a motorist, the scoring component 450 may assign lower scores to points of interest that are less accessible by car (e.g., streets that are closed to private vehicles, or where parking is notoriously difficult to find). The scoring component 450 may consult any suitable source of contextual information, including, but not limited to, search history (e.g., whether the user frequently selects walking and/or public transportation as search options), location tracking (e.g., whether the user's currently movement is consistent with the user walking and/or using public transportation), device identification (e.g., whether the received query indicates a device type, operating system, user agent, etc. consistent with a mobile phone, as opposed to a device incorporated into a vehicle), etc.

In some embodiments, the scoring component 450 may be programmed to use text similarity and/or pronunciation similarity to assign scores to candidate point-of-interest entries. For instance, in the example shown in FIG. 4, the illustrative point-of-interest recognition system 400 includes a text layer fuzzy matching component 410, which may be programmed to compute, for a candidate point-of-interest entry, one or more text similarity scores indicative of how textually similar the candidate point-of-interest entry is to the input text. Additionally, or alternatively, the illustrative point-of-interest recognition system 400 includes a pronunciation layer fuzzy matching component 440, which may be programmed to compute, for a candidate point-of-interest entry, one or more pronunciation similarity scores indicative of how similar the candidate point-of-interest entry is to the input text in pronunciation.

In some embodiments, the scoring component 450 may combine one or more text similarity scores output by the text layer fuzzy matching component 410 and one or more pronunciation similarity scores output by the pronunciation layer fuzzy matching component 440. For example, the scoring component 450 may compute a weighted sum of the text similarity and pronunciation similarity scores. The inventors have recognized and appreciated that some languages (e.g., Chinese) may have many homophones and, as a result, ASR errors involving homophones may be common. Accordingly, in some embodiments, pronunciation similarity may be given more weight than text similarity for languages with many homophones (e.g., Chinese), so as to improve robustness against recognition errors.

In some embodiments, the text layer fuzzy matching component 410 may generate a text similarity score by comparing, textually, an input text against a candidate point-of-interest entry. For instance, the text layer fuzzy matching component 410 may be programmed to generate the text similarity score as follows, based on an edit distance metric between the input text and the point-of-interest name.

text_sim (input text, POI name) =1−edit_dist (input text, POI name)/max_length (input text, POI name)

As one example of an edit distance metric, a Levenshtein distance between an input text “Boston Logan Airport” and a candidate point-of-interest entry “Boston Logan International Airport” may be 1, because a single edit (i.e., inserting “International” between “Logan” and “Airport”) is sufficient to convert the input text “Boston Logan Airport” into the candidate point-of-interest entry “Boston Logan International Airport.” As another example of an edit distance metric, a Damerau-Levenshtein distance between an input text “City Hall Boston” and a candidate point-of-interest entry “Boston City Hall” may be 2, because at least two edits (e.g., transposing “Boston” and “Hall” and then transposing “Boston” and “City,” or deleting “Boston” at the end and adding “Boston” at the beginning) are needed to convert the input text “City Hall Boston” into the candidate point-of-interest entry “Boston City Hall.” Additionally, or alternatively, one or more other metrics (e.g., metrics based on deleting, inserting, substituting, and/or transposing characters, rather than words) may be used, as aspects of the present disclosure are not limited to the use of any particular metric.

In some embodiments, in generating a text similarity score, the text layer fuzzy matching component 410 may differentiate text segments that occur in a certain vocabulary list (e.g., segments that each occur in at least one point-of-interest entry) from text segments that do not. For instance, a text similarity between an input text and a candidate point-of-interest entry may be computed as follows, where LCS denotes a degree of longest common subsequence, M denotes the number of characters in text segments that each occur in at least one point-of-interest entry, and N denotes the number of characters in text segments that do not occur in any point-of-interest entry.

(LCS (input text, POI name)−M)/N

For example, the text layer fuzzy matching component 410 may process an input text, “ [symbol] ” (“Chinese Farmer Bank”), and determine that each of the segments “ [symbol] ” (“Chinese”) and “ [symbol] ” (“Bank”) occurs in one or more point-of-interest entries, but the segment “ [symbol] ” (“Farmer”) does not occur in any point-of-interest entry. Accordingly, a text similarity between the input text “ [symbol] ” (“Chinese Farmer Bank”) and a candidate point-of-interest entry “ [symbol] ” (“Chinese Agricultural Bank”) may be computed as follows.

$$\begin{matrix}LCS ( “ , ” “ ” - M ) / N = ( 5 - 4 ) \text{/} 2 \\ = 0.5\end{matrix}$$

Although various techniques are described herein for measuring text similarity, it should be appreciated that such techniques are merely illustrative. Aspects of the present disclosure are not limited to any particular way of measuring text similarity, or to the use of text similarity to match an input text to one or more point-of-interest entries. Alternatively, or additionally, an input text may be matched to one or more point-of-interest entries based on similarity in pronunciation.

As discussed above, the text-to-pronunciation conversion component 430 of the illustrative point-of-interest recognition system 400 may be programmed to generate a phonetic representation of an input text. In some embodiments, a phonetic representation may include a sequence of syllables, where each syllable may include a sequence of phonemes and each phoneme may include a vowel or a consonant. Additionally, each syllable may include one or more annotations, such as an annotation indicative of a tone for the syllable. For example, an input text, “ [symbol] ” (meaning “Chinese Dragon Night Bank,” which likely includes one or more transcription errors), may have the following phonetic representation.

zhong-1 guo-2 long-2 ye-4 yin-2 hang-2

On the other hand, a candidate point-of-interest entry “ [symbol] ” (“Chinese Agricultural Bank”) may have the following phonetic representation.

zhong-1 guo-2 nong-2 ye-4 yin-2 hang-2

In this example, the initial segment of the input text, “ [symbol] ” (“Chinese”), is identical to the initial segment of the candidate point-of-interest entry, and the final segment of the input text, “ [symbol] ” (“Bank”), is identical to the final segment of the candidate point-of-interest entry. The fourth character of the input text, “ [symbol] ” (“Night”), has the same pronunciation as the fourth character of the candidate point-of-interest entry, “ [symbol] ” (“Industry”). The third character of the input text “ [symbol] ” (“Dragon”) has a similar, but not identical, pronunciation as the third character of the candidate point-of-interest entry “ [symbol] ” (“Agriculture”)—“long-2” vs. “nong-2,” the only difference being in the consonants, “l” vs. “n.”

Thus, five out of six positions in the sequence above have identical pronunciation. A similarity score for each such position may be 1. For the third position, “long-2” vs. “nong-2,” a similarity score may be 0.75. Accordingly, a degree of fuzzy longest common subsequence (fLCS) between the input text “ [symbol] ” and the candidate point-of-interest entry “ [symbol] [symbol] ” may be computed as follows.

1+1+0.75+1+1+1=5.75

In some embodiments, the pronunciation layer fuzzy matching component 440 of the illustrative point-of-interest recognition system 400 may compute a pronunciation similarity as follows, where fLCS denotes a degree of fuzzy longest common subsequence, M denotes the number of characters in text segments that each occur in at least one point-of-interest entry, and N denotes the number of characters in text segments that do not occur in any point-of-interest entry.

(fLCS (phonetic rep. of input text, phonetic rep. of POI name)−M)/N

In the above example, each of the segments “ [symbol] ” (“Chinese”) and “ [symbol] ” (“Bank”) occurs in one or more point-of-interest entries, but the segment “ [symbol] ” (“Dragon Night”) does not occur in any point-of-interest entry. Thus, a pronunciation similarity may be computed as follows.

$$\begin{matrix}\begin{matrix}( fLCS ( phonetic rep . of input text , phonetic rep . \\ of POI name ) - M ) \text{/} N\end{matrix} = ( 5.75 - 4 ) \text{/} 2 \\ = 0.875\end{matrix}$$

Any suitable combination of one or more techniques may be used to compute a degree of similarity between two phonetic representations, as aspects of the present disclosure are not so limited. For example, in some embodiments, a degree of similarity between two syllables A and B may be computed as follows, based on a degree of similarity between the consonants of A and B and a degree of similarity between the vowels of A and B.

(sim_con (A.consonant, B.consonant)+sim_vow (A.vowel, B.vowel))/2

A degree of similarity between two consonants may be defined in any suitable way, and likewise for a degree of similarity between two vowels. For example, a degree of similarity between identical consonants may be 1, a degree of similarity between two highly confusable consonants (e.g., “l” vs. “n,” “s” vs. “sh,” “b” vs, “p,” etc.) may be 0.5, a degree of similarity between two moderately confusable consonants (e.g., “s” vs. “z,” “s” vs. “th,” etc.) may be 0.25, etc. Likewise, a degree of similarity between identical vowels may be 1, a degree of similarity between two highly confusable vowels (e.g., “i” as in “fit” vs. “ee” as in “feet,” “an” as in “ban” vs. “ang” as in “bang,” “in” as in “sin” vs. “ing” as in “sing,” etc.) may be 0.5, a degree of similarity between two moderately confusable vowels (e.g., “o” as in “hot” vs. “u” as in “hut,” “a” as in “bad” vs. “e” as in “bed,” etc.) may be 0.25, etc.

The inventors have recognized and appreciated that confusability may vary depending on one or more factors, including, but not limited to, a particular ASR engine used, a particular language and/or accent, a particular speaker, etc. Accordingly, in some embodiments, the grouping of consonants and/or vowels, and/or the assignment of values to the different groups may be based on test data. Additionally, or alternatively, one or more special rules may be provided for certain pairs of syllables (e.g., “wang” vs. “huang,” “wa” vs. “hua,” “wu” vs. “hu,” “wen” vs. “hun,” etc.).

In some embodiments, a recognized text received and processed by the illustrative point-of-interest recognition system 400 may include n-best result, for some suitable n , output by a speech recognition system (e.g., the illustrative speech recognition system 200 shown in FIG. 2). The n-best result may include n sequences of one or more words, where each sequence is a likely match of a user utterance. The point-of-interest recognition system 400 may process some or all of the n sequences to identify potentially matching point-of-interest entries. However, it should be appreciated that aspects of the present disclosure are not limited to receiving an n-best result from a speech recognition system, as in some embodiments a single sequence of one or more words may be provided as input to the point-of-interest recognition system 400.

In some embodiments, the illustrative point-of-interest recognition system 400 may identify, for each sequence in an n-best result, one or more point-of-interest candidates as potentially matching the sequence. For example, the scoring component 450 may be programmed to maintain a list of point-of-interest candidates with respective scores. Given a candidate for an i-th sequence in the n-best result, a score may be computed as follows, where wf is an appropriate weighting function, and sim_score is a similarity between the candidate and the i-th sequence (e.g., computed as a weighted sum of text similarity and pronunciation similarity as discussed above).

candidate_score (candidate, i-th sequence in n-best result) =sim_score (candidate, i-th sequence in n-best result)*wf(i)/(wf(1)+ . . . +wf(n))

If a point-of-interest entry is a candidate for multiple sequences in the n-best result, a score for the point-of-interest entry may be the sum of candidate score (point-of-interest entry, i-th sequence in n-best result) over all values of i for which the point-of-interest entry is a candidate.

The weighting function wf may be chosen in any suitable manner. For instance, in some embodiments, a weighting function may be selected from a group of suitable functions, including, but not limited to, the following.

wf(i)=1/i

wf(i)=1/2ⁱ

wf(i)=(n−i+1)/n

wf(i)=1

For example, each of these functions may be applied to test data, and a function with a highest accuracy (e.g., a highest F-score) may be selected. However, it should be appreciated that aspects of the present disclosure are not limited to any particular way for selecting a weighting function, or to the use of any weighting function at all.

In some embodiments, the point-of-interest recognition system 400 may use scores computed by the scoring component 450 to rank candidate point-of-interest entries and output an n-best result for some suitable n (which may be the same as, or different from, the number of sequences of one or more words received by the point-of-interest recognition system 400 as input). The scores may, although need not, be output along with the n-best result. In some embodiments, n may be equal to 1, in which case the point-of-interest recognition system 400 may output a single point-of-interest candidate.

In some embodiments, the point-of-interest recognition system 400 may present (e.g., visually, audibly, etc.) one or more candidate point-of-interest entries to a user based on the respective scores (e.g., with the scores in descending order so that the best match is presented first). The point-of-interest recognition system 400 may, although need not, limit the number of candidate point-of-interest entries presented to the user at one time, for example, to one entry, two entries, three entries, etc. This may reduce a cognitive burden on a user who may be walking or driving.

Although various examples are described above in connection with FIG. 4, it should be appreciated that such examples are provided solely for purposes of illustration.

FIG. 5 shows an illustrative process 500 for matching an input text to one or more candidate point-of-interest entries, in accordance with some embodiments. For example, the illustrative process 500 may be performed by a point-of-interest recognition system (e.g., the illustrative point-of-interest recognition system 100 shown in FIG. 1 and/or the illustrative point-of-interest recognition system 400 shown in FIG. 4) to process a point-of-interest query received from a user.

At act 510, an input text may be segmented in some suitable way, such as using one or more of the segmentation techniques described herein. For example, an input text “ [symbol] [symbol] ” (“Western Brilliance Shopping Mall”) may be segmented into three segments, “ [symbol] [symbol] ” (“Western”|“Brilliance”|“Shopping Mall”).

At act 520, an index may be retrieved for at least one segment identified at act 510. For example, in an embodiment in which segments of point-of-interest names are sorted in encoded form, a segment identified at act 510 may be encoded, and a resulting encoding may be used to search for a match in a list of encoded segments.

In some embodiments, an index retrieved for a segment may be in encoded form (e.g., having been encoded using a delta encoding scheme). Such an index may be decoded to recover one or more identifiers for point-of-interest entries in which the corresponding segment occurs. However, it should be appreciated that aspects of the present disclosure are not limited to encoding and subsequent decoding of indices, as in some embodiments an index may be stored without being encoded, so that no decoding may be performed.

In some embodiments, no corresponding index may be found for an identified segment, which may indicate that the segment does not appear in any known point-of-interest entry. However, in some embodiments, such segments may be taken into account in evaluating similarity (e.g., text similarity and/or pronunciation similarity) between an input text and a candidate point-of-interest entry, for example, as discussed above in connection with FIG. 4.

In some embodiments, segments for which an index is found may be placed in a first list, whereas segments for which no index is found may be placed in a second list. At act 530, it may be determined whether there is at least one point-of-interest entry in which all segments in the first list occur. For example, a set of one or more point-of-interest entries may be identified for each segment in the first list (e.g., including all point-of-interest entries in the retrieved index for the segment), and an intersection may be taken of all such sets.

If the intersection is non-empty, one or more point-of-interest entries in the intersection may be output at act 540 as candidates. Otherwise, at act 535, at least one segment may be removed from the first list and placed into the second list, and the process 500 may return to act 530 to take an intersection of all sets corresponding to segments in the first list. Because at least one segment has been removed from the first list, the intersection may become non-empty. If so, the process 500 may proceed to act 540. Otherwise, the process 500 may proceed to act 535 again to remove at least one other segment. This may be repeated until the intersection becomes non-empty.

Any suitable technique may be used to select one or more segments to be removed from the first list. For instance, in some embodiments, one or more statistical techniques may be used to analyze a point-of-interest database (e.g., the illustrative segmented point-of-interest database 230 shown in FIG. 2) and to score segments of point-of-interest names based on information content. For example, a segment that occurs rarely may be treated as having higher information content than a segment that occurs frequently. Accordingly, a segment with the lowest frequency of occurrence may be removed at act 535.

Alternatively, or additionally, category words may be removed (e.g., “Hotel,” “Supermarket,” etc.), while names may be retained (e.g., “Sheraton,” “Carrefour,” etc.). For example, the user who spoke the input text “ [symbol] ” (“Western Brilliance Shopping Mall”) may have intended to search for “ [symbol] [symbol] ” (“Shanghai Western Brilliance Shopping Center”). The input text “ [symbol] ” (“Western Brilliance Shopping Mall”) may initially lead to an empty intersection, because there may be no entry in which all three segments, “ [symbol] ” (“Western”), “ [symbol] ” (“Brilliance”), and “ [symbol] ” (“Shopping Mall”), occur. By removing the category word “ [symbol] ” (“Shopping Mall”) and taking an intersection of only the two candidate sets corresponding respectively to the segments “ [symbol] ” (“Western”) and “ [symbol] ” (“Brilliance”), a non-empty intersection may result, which may include the intended point-of-interest entry, “ [symbol] [symbol] ” (“Shanghai Western Brilliance Shopping Center”).

Although various examples are described above in connection with FIG. 5, it should be appreciated that such examples are provided solely for purposes of illustration. For instance, aspects of the present disclosure are not limited to sorting segments of point-of-interest names in encoded form, as in some embodiments segments of point-of-interest names may be sorted in decoded form, and a segment identified at act 510 may be used to identify a match in a list of segments, without first being encoded.

Furthermore, in some embodiments, point-of-interest entries from different geographic regions (e.g., different countries, provinces, cities, etc.) may be compiled into separate databases. In this manner, a smaller amount of information (e.g., only one database) may be kept in memory at any given time. In some such embodiment, if the process 500 fails to identify any candidate point-of-interest entry, a database that is currently loaded into memory may be moved into cache, and a different database may be loaded and the process 500 may be performed using the newly loaded database. This may be done in addition to, or instead of, moving segments from the first list to the second list to obtain a potentially non-empty intersection.

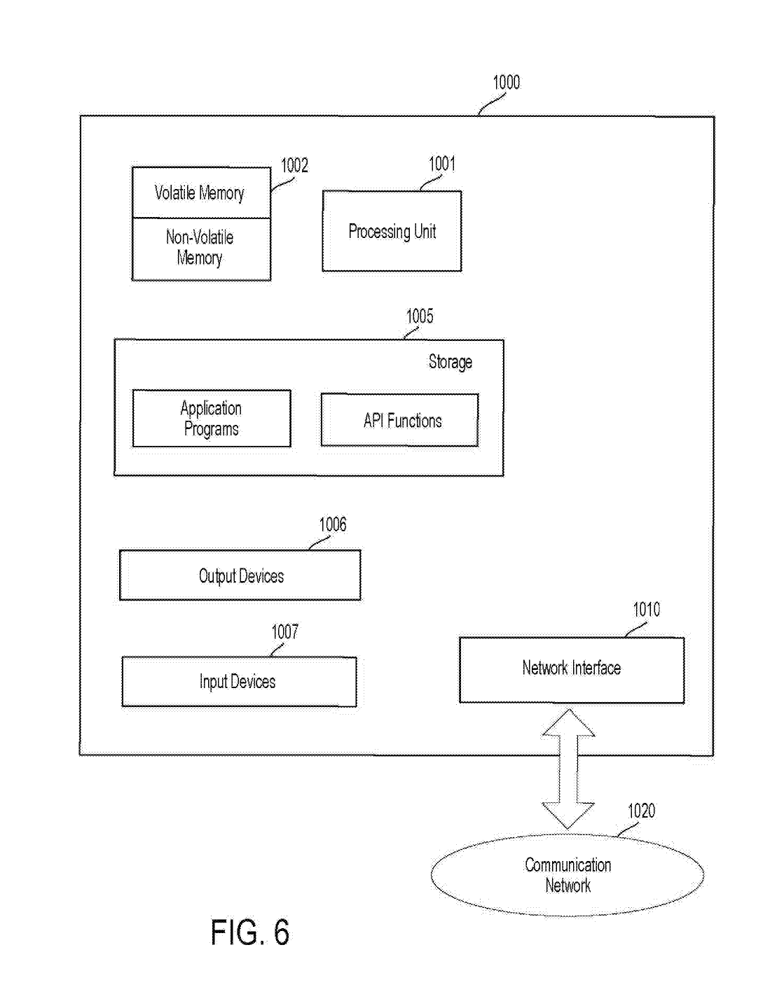

FIG. 6 shows, schematically, an illustrative computer 1000 on which any aspect of the present disclosure may be implemented. For example, any one or more of the illustrative components shown in FIGS. 1-2 and 4 (e.g., the ASR engine 110, the point-of-interest recognition component 120, and/or the point-of-interest database 130 ) may be implemented on the computer 1000.

As used herein, a “mobile device” may be any computing device that is sufficiently small so that it may be built into or installed in a vehicle, or carried by a user. Examples of mobile devices include, but are not limited to, computing devices integrated into vehicles, mobile phones, pagers, portable media players, e-book readers, handheld game consoles, personal digital assistants (PDAs), and tablet computers. In some instances, the weight of a mobile device may be at most one pound, one and a half pounds, or two pounds, and/or the largest dimension of a mobile device may be at most six inches, nine inches, or one foot. Additionally, a mobile device may include features that enable the user to use the device at diverse locations. For example, a mobile device may include a power storage (e.g., battery) so that the mobile device may be used for some duration without being plugged into a power outlet or may rely on a battery of a vehicle. As another example, a mobile device may include a wireless network interface configured to provide a network connection without being physically connected to a network connection point.

In the embodiment shown in FIG. 6, the computer 1000 includes a processing unit 1001 having one or more processors and a non-transitory computer-readable storage medium 1002 that may include, for example, volatile and/or non-volatile memory. The memory 1002 may store one or more instructions to program the processing unit 1001 to perform any of the functions described herein. The computer 1000 may also include other types of non-transitory computer-readable medium, such as storage 1005 (e.g., one or more disk drives) in addition to the memory 1002. The storage 1005 may also store one or more application programs and/or resources used by application programs (e.g., software libraries), which may be loaded into the memory 1002.

The computer 1000 may have one or more input devices and/or output devices, such as devices 1006 and 1007 illustrated in FIG. 6. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 1007 may include a microphone for capturing audio signals, and the output devices 1006 may include a display screen for visually rendering, and/or a speaker for audibly rendering, recognized text.

As shown in FIG. 6, the computer 1000 may also comprise one or more network interfaces (e.g., the network interface 1010 ) to enable communication via various networks (e.g., the network 1020 ). Examples of networks include a local area network or a wide area network, such as an enterprise network or the Internet. Such networks may be based on any suitable technology and may operate according to any suitable protocol and may include wireless networks, wired networks, or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A system comprising:
at least one processor; and
at least one computer-readable storage medium storing a plurality of point-of-interest segment indices, wherein the at least one computer-readable storage medium further stores instructions which program the at least one processor to:
match a first text segment to a first point-of-interest segment index stored in the at least one computer-readable storage medium;
match a second text segment to a second point-of-interest segment index stored in the at least one computer-readable storage medium; and
use the first and second point-of-interest segment indices to identify one or more candidate point-of-interest entries matching both the first and second text segments.

2. The system of claim 1, wherein the at least one processor is programmed to:
use the first point-of-interest segment index to identify a first set of one or more point-of-interest entries matching the first text segment;
use the second point-of-interest segment index to identify a second set of one or more point-of-interest entries matching the second text segment; and
identify, as the one or more candidate point-of-interest entries, one or more point-of-interest entries that occur both in the first set and in the second set.

3. The system of claim 1, wherein the at least one computer-readable storage medium further stores a language model, the language model comprising statistical information relating to a plurality of point-of-interest segments, and wherein the at least one processor is further programmed to:
use the language model to recognize the first and second text segments from an input audio signal.

4. The system of claim 3, wherein:
the first text segment comprises a first point-of-interest segment of the plurality of point-of-interest segments, the first point-of-interest segment corresponding to the first point-of-interest segment index; and
the second text segment comprises a second point-of-interest segment of the plurality of point-of-interest segments, the second point-of-interest segment corresponding to the second point-of-interest segment index.

5. The system of claim 1, wherein the at least one processor is further programmed to:
associate a first score with a first candidate point-of-interest entry, the first score being indicative of how similar the first candidate point-of-interest entry is to the first and second text segments;
associate a second score with a second candidate point-of-interest entry, the second score being indicative of how similar the second candidate point-of-interest entry is to the first and second text segments; and
rank the first and second candidate point-of-interest entries based at least in part on the first and second scores.

6. The system of claim 5, wherein the at least one processor is further programmed to:
generate a text score at least in part by comparing, textually, the first and second text segments against a point-of-interest name of the first candidate point-of-interest entry;
generate a pronunciation score at least in part by comparing a phonetic representation of the first and second text segments against a phonetic representation of the point-of-interest name of the first candidate point-of-interest entry; and
generate the first score as a weighted sum of the text and pronunciation scores.

7. The system of claim 1, wherein the plurality of point-of-interest segment indices are stored in an encoded form, and wherein the at least one processor is further programmed to:
decode the first and second point-of-interest segment indices prior to using the first and second point-of-interest segment indices to identify one or more candidate point-of-interest entries matching both the first and second text segments.

8. A method performed by a system comprising at least one processor and at least one computer-readable storage medium storing a plurality of point-of-interest segment indices, the method comprising acts of:
matching a first text segment to a first point-of-interest segment index stored in the at least one computer-readable storage medium;
matching a second text segment to a second point-of-interest segment index stored in the at least one computer-readable storage medium; and
using the first and second point-of-interest segment indices to identify one or more candidate point-of-interest entries matching both the first and second text segments.

9. The method of claim 8, wherein the act of using the first and second point-of-interest segment indices to identify one or more candidate point-of-interest entries comprises acts of:
using the first point-of-interest segment index to identify a first set of one or more point-of-interest entries matching the first text segment;
using the second point-of-interest segment index to identify a second set of one or more point-of-interest entries matching the second text segment; and
identifying, as the one or more candidate point-of-interest entries, one or more point-of-interest entries that occur both in the first set and in the second set.

10. The method of claim 8, wherein the at least one computer-readable storage medium further stores a language model, the language model comprising statistical information relating to a plurality of point-of-interest segments, and wherein the method further comprises an act of:
using the language model to recognize the first and second text segments from an input audio signal.

11. The method of claim 10, wherein:
the first text segment comprises a first point-of-interest segment of the plurality of point-of-interest segments, the first point-of-interest segment corresponding to the first point-of-interest segment index; and
the second text segment comprises a second point-of-interest segment of the plurality of point-of-interest segments, the second point-of-interest segment corresponding to the second point-of-interest segment index.

12. The method of claim 8, further comprising acts of:
associating a first score with a first candidate point-of-interest entry, the first score being indicative of how similar the first candidate point-of-interest entry is to the first and second text segments;
associating a second score with a second candidate point-of-interest entry, the second score being indicative of how similar the second candidate point-of-interest entry is to the first and second text segments; and
ranking the first and second candidate point-of-interest entries based at least in part on the first and second scores.

13. The method of claim 12, further comprising acts of:
generating a text score at least in part by comparing, textually, the first and second text segments against a point-of-interest name of the first candidate point-of-interest entry;
generating a pronunciation score at least in part by comparing a phonetic representation of the first and second text segments against a phonetic representation of the point-of-interest name of the first candidate point-of-interest entry; and
generating the first score as a weighted sum of the text and pronunciation scores.

14. The method of claim 8, wherein the plurality of point-of-interest segment indices are stored in an encoded form, and wherein the method comprises an act of:
decoding the first and second point-of-interest segment indices prior to using the first and second point-of-interest segment indices to identify one or more candidate point-of-interest entries matching both the first and second text segments.

15. At least one computer-readable storage medium storing a plurality of point-of-interest segment indices, the at least one computer-readable storage medium further storing instructions which program at least one processor perform a method comprising acts of:
matching a first text segment to a first point-of-interest segment index stored in the at least one computer-readable storage medium;
matching a second text segment to a second point-of-interest segment index stored in the at least one computer-readable storage medium; and
using the first and second point-of-interest segment indices to identify one or more candidate point-of-interest entries matching both the first and second text segments.

16. The at least one computer-readable storage medium of claim 15, wherein the act of using the first and second point-of-interest segment indices to identify one or more candidate point-of-interest entries comprises acts of:
using the first point-of-interest segment index to identify a first set of one or more point-of-interest entries matching the first text segment;
using the second point-of-interest segment index to identify a second set of one or more point-of-interest entries matching the second text segment; and
identifying, as the one or more candidate point-of-interest entries, one or more point-of-interest entries that occur both in the first set and in the second set.

17. The at least one computer-readable storage medium of claim 15, further storing a language model, the language model comprising statistical information relating to a plurality of point-of-interest segments, wherein the method further comprises an act of:
using the language model to recognize the first and second text segments from an input audio signal.

18. The at least one computer-readable storage medium of claim 17, wherein:
the first text segment comprises a first point-of-interest segment of the plurality of point-of-interest segments, the first point-of-interest segment corresponding to the first point-of-interest segment index; and
the second text segment comprises a second point-of-interest segment of the plurality of point-of-interest segments, the second point-of-interest segment corresponding to the second point-of-interest segment index.

19. The at least one computer-readable storage medium of claim 15, wherein the method further comprises acts of:
associating a first score with a first candidate point-of-interest entry, the first score being indicative of how similar the first candidate point-of-interest entry is to the first and second text segments;
associating a second score with a second candidate point-of-interest entry, the second score being indicative of how similar the second candidate point-of-interest entry is to the first and second text segments; and
ranking the first and second candidate point-of-interest entries based at least in part on the first and second scores.

20. The at least one computer-readable storage medium of claim 19, wherein the method further comprises acts of:
generating a text score at least in part by comparing, textually, the first and second text segments against a point-of-interest name of the first candidate point-of-interest entry;
generating a pronunciation score at least in part by comparing a phonetic representation of the first and second text segments against a phonetic representation of the point-of-interest name of the first candidate point-of-interest entry; and
generating the first score as a weighted sum of the text and pronunciation scores.
